(19) United States
(12) Patent Application Publication
(10) Pub. No.: US 2025/0146117 A1
(43) Pub. Date: May 8, 2025

(54) CERAMIC THERMAL SPRAY PARTICLES AND METHOD FOR FORMING THERMAL BARRIER COATING LAYER

(71) Applicant: MITSUBISHI HEAVY INDUSTRIES, LTD., Tokyo (JP)

(72) Inventors: Taiji TORIGOE, Tokyo (JP); Yoshifumi OKAJIMA, Tokyo (JP); Masahiko MEGA, Tokyo (JP); Hiroki KOMURO, Tokyo (JP); Kazuma TAKENO, Tokyo (JP)

(21) Appl. No.: 18/833,039

(22) PCT Filed: Jun. 6, 2023
(86) PCT No.: PCT/JP2023/020990

§ 371 Date: Jul. 25, 2024

(30) Foreign Application Priority Data
Jun. 23, 2022 (JP) 2022-101154

(51) Int. Cl. C23C 4/11

(52) U.S. Cl. CPC C23C 4/11

(57) ABSTRACT

Ceramic thermal spray particles according to the present invention contain ZrO₂ and Yb₂O₃, wherein the standard deviation of the content of the Yb₂O₃ is 2-7.0 mass %.

### TECHNICAL FIELD

The present disclosure relates to ceramic thermal spray particles and a method for forming a thermal barrier coating layer. Priority is claimed to Japanese Patent Application No. 2022-101154, filed Jun. 23, 2022, the contents of which are incorporated herein by reference.

### BACKGROUND ART

Efforts are being made to increase efficiency and temperature of industrial gas turbines, and a thermal barrier coating (TBC) formed on a high-temperature member is an important element. The thermal barrier coating is formed, for example, by plasma spraying of a thermal spray material.

Ceramic thermal spray particles as a thermal spray material are manufactured by, for example, a spray dryer. PTL 1 discloses a method for manufacturing hollow ceramic powder for thermal spraying, the method including:

preparing a stabilizer and a surfactant as raw materials of a main agent of high purity zirconium oxide (ZrO₂); adding water to the raw materials; dispersing and homogenizing the solution; further adding water to prepare a slurry such that a ratio between the raw materials and the water is 1:1; dropping and ejecting the prepared. slurry using an atomizer that rotates at a high speed to prepare particles; drying and swirling the particles with high-temperature swirling air in a cyclone to evaporate moisture from an outer peripheral side of the particles such that hollow ceramic powder is obtained; and sintering and solidifying the hollow ceramic powder through a heat treatment.

### CITATION LIST

### Patent Literature

[PTL 1] Japanese Patent No. 3825231

### SUMMARY OF INVENTION

### Technical Problem

However, a thermal barrier coating having a lower thermal conductivity than a thermal barrier coating that is formed of the ceramic thermal spray particles manufactured using the manufacturing method described in PTL 1 is required. Further, the thermal barrier coating is also required to have high thermal cycle durability.

The present disclosure has been made in order to solve the problems, and an object thereof is to provide ceramic thermal spray particles and a method for forming a thermal barrier coating layer, in which a thermal barrier coating having a low thermal conductivity and excellent thermal cycle durability can be formed.

### Solution to Problem

Ceramic thermal spray particles according to the present disclosure contain ZrO₂ and Yb₂O₃, Y in which a standard deviation of content of Yb₂O₃ is 2 mass % or more and 7.0 mass % or less.

A method for forming a thermal barrier coating layer according to the present disclosure includes: a metal bonding layer forming step of forming a metal bonding layer on a substrate; and a ceramic layer forming step of thermally spraying ceramic thermal spray particles onto the metal bonding layer to form a ceramic layer, in which the ceramic thermal spray particles contain ZrO₂ and Yb₂O₃, and a standard deviation of content of Yb₂O₃ in the ceramic thermal spray particles is 2 mass % or more and 7.0 mass % or less.

### Advantageous Effects of Invention

In the ceramic thermal spray particles and the method for forming the thermal barrier coating layer according to the present disclosure, a thermal barrier coating having a low thermal conductivity and excellent thermal cycle durability can be formed.

### BRIEF DESCRIPTION OF DRAWINGS

FIG. 1 is a schematic cross-sectional view showing a heat-resistant member according to the present disclosure.

FIG. 2 is a flowchart showing a method for forming a thermal barrier coating layer according to the present disclosure.

FIG. 3 is a flowchart showing method for manufacturing ceramic thermal spray particles according to the present disclosure.

FIG. 4 is a schematic cross-sectional view showing a laser type thermal cycle tester.

FIG. 5 is a diagram showing a relationship showing a thermal conductivity and a standard deviation of Yb₂O₃ in the ceramic thermal spray particles.

FIG. 6 is a diagram showing a relationship showing thermal cycle durability and the standard deviation of Yb₂O₃ in the ceramic thermal spray particles.

FIG. 7 is a diagram showing a relationship between the thermal cycle durability and a cumulative particle size d10 of the ceramic thermal spray particles.

### DESCRIPTION OF EMBODIMENTS

### Heat-Resistant Member

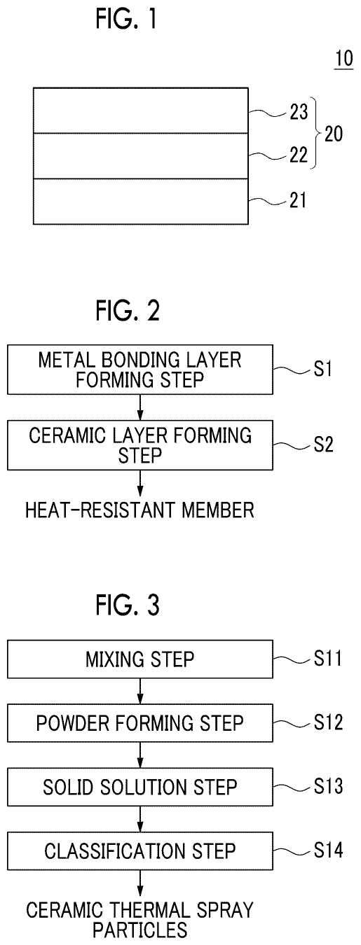

Hereinafter, a heat-resistant member where a thermal barrier coating layer according to the present disclosure is formed will be described. FIG. 1 is a schematic cross-sectional view showing a heat-resistant member 10 according to the present disclosure. The heat-resistant member 10 includes a substrate 21, a metal bonding layer 22 that is formed on the substrate 21, and a ceramic layer 23 that is formed on the metal bonding layer 22. A thermal barrier coating layer 20 is provided between the metal bonding layer 22 and the ceramic layer 23.

### Substrate 21

The substrate 21 is, for example, a high-temperature heat-resistant alloy substrate such as a rotating blade. A chemical composition of the substrate 21 includes, for example, by mass %, Ni: 20 to 40 mass %, Cr: 10 to 30 mass %, Al: 4 to 15 mass %, Y: 0.1 to 5 mass %, Re: 0.5 to 10 mass %, and Co: the remainder. In the present specification, a numerical range represented by “to” refers to a range including numerical values described before and after “to” as a lower limit value and an upper limit value. A numerical value representing “less than” or “more than” is not included in a numerical range.

### Metal Bonding Layer 22

The metal bonding layer 22 is directly formed on the substrate 21. The metal bonding layer 22 reduces difference in thermal expansion coefficient between the substrate 21 and the ceramic layer 23, and alleviates thermal stress. As a result, peeling of the ceramic layer 23 from the metal bonding layer 22 is suppressed. In addition, the metal bonding layer 22 suppresses high-temperature oxidation and high-temperature corrosion of the substrate 21. It is preferable that a material having excellent corrosion resistance and oxidation resistance is used for the metal bonding layer 22. The metal bonding layer 22 is, for example, an MCrAlY alloy. M in the MCrAlY alloy represents a metal element, for example, a single metal element among Ni, Co, Fe, and the like or two or more metal elements among the metal elements.

### Ceramic Layer

The ceramic layer 23 is formed of ZrO₂ that is partially stabilized by Yb₂O₃ (hereinafter, referred to as YbSZ). The ceramic layer 23 may contain impurities other than Yb₂O₃ and ZrO₂ The impurities are, for example, components that are mixed in raw materials or components that are mixed in a manufacturing step. The ceramic layer 23 formed of YbSZ has excellent crystal stability. Therefore, the occurrence of stress derived from phase transformation can be suppressed.

The content of ZrO₂ is 75 mass % or more with respect to a total mass of the thermal barrier coating layer 20. The content of ZrO₂ is more preferably 80 mass % or more. The content of ZrO₂ is 90 mass % or less. The content of ZrO₂ is more preferably 84 mass % or less.

The content of Yb₂O₃ is preferably 10 mass % or more with respect to the total mass of the thermal barrier coating layer 20. By adjusting the content of Yb₂O₃ to be 10 mass % or more, thermal cycle durability of the thermal barrier coating layer 20 is improved. The content of Yb₂O₃ is more preferably 16 mass % or more. The content of Yb₂O₃ is preferably 25 mass % or less. When the content of Yb₂O₃ exceeds 25 mass %, the durability of the thermal barrier coating layer 20 may decrease. The content of Yb₂O₃ is more preferably 20 mass % or less.

A standard deviation of content of Yb₂O₃ in the ceramic layer 23 is 2 mass % or more and 7.0 mass % or less. When the standard deviation of content of Yb₂O₃ is less than 2 mass %, thermal conductivity of the ceramic layer 23 increases, which is not preferable. When the standard deviation of content of Yb₂O₃ exceeds 7.0 mass %, the thermal cycle durability decreases, which is not preferable.

The chemical compositions of the metal bonding layer 22 and the ceramic layer 23 can be analyzed using a well-known method. For example, a cross-section of a sample for observation obtained by cutting the heat-resistant member 10 is randomly analyzed at 10 points by an electron probe microanalyzer. The contents of Yb₂O₃ and the contents of ZrO₂ are calculated from each of the obtained Contents (at %) of Yb and Zr. The average value of the obtained contents of Yb₂O₃ is set as the content of Yb₂O₃. In addition, the average value of the obtained contents of ZrO₂ is set as the content of ZrO₂. Likewise, the standard deviation of Yb₂O₃ and the standard deviation of ZrO₂ can also be evaluated.

In the ceramic layer 23, a porosity is preferably 4% or more and 20% or less. The porosity of the ceramic layer 23 refers to an area ratio of pores in the ceramic layer 23. The porosity can be obtained, for example, using an image processing method by observing a cross-section of the ceramic layer 23 using an optical microscope (magnification: 100-fold) randomly in five fields of view (observation length: about 3 mm).

The thickness of the ceramic layer 23 is preferably 0.1 to 1.5 mm. When the thickness of the ceramic layer 23 is less than 0.1 mm, thermal barrier characteristics of the ceramic layer 23 may be insufficient. When the thickness of the ceramic layer 23 exceeds 5 mm, the ceramic layer 23 is likely to peel off, and the durability of the ceramic layer 23 may decrease.

Next, the heat-resistant member 10 will be described. By forming the ceramic layer 23 using ZrO₂ that is stabilized by Yb₂O₃, the crystal stability of the ceramic layer 23 is improved. In addition, even when a high-temperature member such as a turbine is used, a crystal phase of the ceramic layer 23 during a thermal cycle is not likely to change, and cracks caused by phase transformation and propagation thereof cannot be prevented.

### Method for Forming Thermal Barrier Coating Layer

A method for forming the thermal barrier coating layer 20 according to the present disclosure will be described. FIG. 2 is a flowchart showing the method for forming the thermal barrier coating layer 20. The method for forming the thermal barrier coating layer 20 includes: a metal bonding layer forming step S1 of forming the metal bonding layer 22 on the substrate 21; and a ceramic layer forming step S2 of thermally spraying ceramic thermal spray particles onto the metal bonding layer 22 to form the ceramic layer 23 after the metal bonding layer forming step S1.

### Metal Bonding Layer Forming Step S1

In the metal bonding layer forming step S1, the metal bonding layer 22 is formed on the substrate 21. The method for forming the metal bonding layer 22 is not particularly limited. The metal bonding layer 22 can be formed using a low-pressure plasma spraying method, an electron beam physical vapor deposition method, or the like. The substrate 21 where the metal bonding layer 22 is formed in advance may be prepared as a substrate for thermal spraying.

### Ceramic Layer Forming Step S2

In the ceramic layer forming step S2, the ceramic layer 23 is formed on the metal bonding layer 22. The ceramic layer 23 forms by thermally spraying ceramic thermal spray particles onto the metal bonding layer 22. The thermal spraying method is not particularly limited, and for example, a low-pressure plasma spraying method can be used.

### Ceramic Thermal Spray Particles

Next, the ceramic thermal spray particles used in the ceramic layer forming step S2 will be described. The ceramic thermal spray particles according to the present disclosure contain zirconium oxide (ZrO₂) and ytterbia (Yb₂O₃).

In the ceramic thermal spray particles, the content of ZrO₂ is 75 mass % or more with respect to a total mass of the ceramic thermal spray particles. The content of ZrO₂ is more preferably 80 mass % or more. The content of ZrO₂ is 90 mass % or less. The content of ZrO₂ is more preferably 84 mass % or less.

The content of Yb₂O₃ is preferably 10 mass % or more with respect to the total mass of the ceramic thermal spray particles. By adjusting the content of Yb₂O₃ to be 10 mass % or more, the durability (thermal cycle durability) of the thermal barrier coating layer 20 is improved. The content of Yb₂O₃ is more preferably 16 mass % or more. The content of Yb₂O₃is preferably 25 mass % of less. When the content of Yb₂O₃ exceeds 25 mass %, the durability of the thermal barrier coating layer 20 may decrease. The content of Yb₂O₃ is more preferably 20 mass % or less.

A standard deviation of content of Yb₂O₃ in the ceramic thermal spray particles is 2 mass % or more and 7.0 mass % or less. When the standard deviation of content of Yb₂O₃ is less than 2 mass %, the thermal conductivity of the ceramic layer 23 increases, which is not preferable. The standard deviation of content of Yb₂O₃is preferably 2.0 mass % or more with respect to the total mass of the ceramic thermal spray particles. The standard deviation of content of Yb₂O₃, is still more preferably 2.3 mass % or more. The standard deviation of content of Yb₂O₃ is preferably 5.3 mass % or less. When the standard deviation of content of Yb₂O₃ exceeds 7.0 mass %, the thermal cycle durability decreases, which is not preferable.

An in-plane distribution of the chemical composition of the ceramic thermal spray particles can be analyzed using a well-known method. For example, the ceramic thermal spray particles are embedded in a resin and cut. After cutting the resin, a cross-section is polished to prepare a sample for observation. For example, a cross-section of the obtained sample is randomly analyzed at 10 points by an electron probe microanalyzer. The contents of Yb₂O₃ and the contents of ZrO₂ are calculated from each of the obtained contents (at %) of Yb and Zr. The average value of the obtained contents of Yb₂O₃ is set as the content of Yb₂O₃. In addition, the average value of the obtained contents of ZrO₂ is set as the content of ZrO₂. Likewise, the standard deviation of Yb₂O₃ and the standard. deviation of ZrO₂ are also evaluated.

A cumulative particle size d10 of the ceramic thermal spray particles is preferably 40 μm or more. The cumulative particle size d10 of the ceramic thermal spray particles is more preferably 45 μm or more. When the cumulative particle size d10 of the ceramic thermal spray particles is 40 μm or more, the porosity of the ceramic layer 23 can be improved, and the thermal cycle durability of the ceramic layer 23 can be further improved. The cumulative particle size d10 of the ceramic thermal spray particles is preferably 100 μm or less. The cumulative particle size d10 of the ceramic thermal spray particles is more preferably 51 μm, The cumulative particle size d10 can be measured based on JIS Z 8825:2013. The cumulative particle size d10 refers to a particle size at which 10% of the population falls below the value. The cumulative particle size d10 refers to a particle size corresponding to a cumulative percentage of 10% from a smallest particle size side in a volume distribution curve.

The maximum particle size of the ceramic thermal spray particles is preferably 150 μm or less. By setting the maximum particle size of the ceramic thermal spray particles to be 150 μm or less, the ceramic thermal spray particles can be easily melted satisfactorily by plasma spraying. The maximum particle size of the ceramic thermal spray particles refers to a particle size represented by a minimum pore size of a metal wire sieve through which all the ceramic thermal spray particles pass.

The ceramic thermal spray particles according to the present disclosure are preferably hollow. When the ceramic thermal spray particles are hollow, the porosity of the ceramic layer 23. can be improved, and thermal barrier characteristics can be further improved.

Hereinabove, the ceramic thermal spray particles and the method for forming the thermal barrier coating layer 20 according to the present disclosure have been described. In the ceramic thermal spray particles and the method for forming the thermal barrier coating layer 20 according to the present disclosure, a thermal barrier coating having a low thermal conductivity and excellent thermal cycle durability can be formed.

### Method for Manufacturing Ceramic Thermal Spray Particles

Next, a method for manufacturing the ceramic thermal spray particles according to the present disclosure will be described. FIG. 3 is a flowchart showing the method for manufacturing the ceramic thermal spray particles. The method for manufacturing the ceramic thermal spray particles according to the present disclosure includes: a mixing step S11 of mixing ZrO₂ powder, Yb₂O₃ powder, and water at a predetermined addition ratio to manufacture a slurry; a powder forming step S12 of manufacturing powder from the slurry; a solid solution step S13 of forming a solid solution from the powder; and a classification step S14 of classifying the powder after the formation of the solid solution.

### Mixing Step S11

In the mixing step S11, ZrO₂ powder, Yb₂O₃ powder, and water are mixed at the above-described ratio to manufacture a slurry such that the standard deviation of content of Yb₂O₃ in the ceramic thermal spray particles is 2 mass % or more and 7.0 mass % or less. It is preferable to add a surfactant to the raw materials (ZrO₂ powder, Yb₂O₃ powder, and water). By adding the surfactant, the reseparation of ZrO₂ powder and Yb₂O₃powder that are aggregated can be promoted. A weight ratio between ZrO₂ and Yb₂O₃ powders and water is not particularly limited and is, for example, 1:1. It is preferable to add the slurry, water, and a binder to the slurry before the powder forming step S12.

The mixing of the raw materials can be performed using, for example, a ball mill or a bead mill. When the bead mill is used, a mixing time is, for example, 8 hours to 10 hours. When the mixing time is excessively long, the standard deviation of content of Yb₂O₃ is less than 2 mass %, and the thermal conductivity of the ceramic layer 23 increases. When the mixing time is short, the standard deviation exceeds 7 mass %, and the thermal cycle durability of the ceramic layer 23 decreases. Mixing conditions change depending on a mixing device. Therefore, it is preferable that the mixing conditions are appropriately adjusted depending on the device.

When the bead mill is used, a rotation speed during the mixing of the raw materials is, for example, 10 to 30 rpm. The rotation speed can be appropriately adjusted depending on the mixing device.

### Powder Forming Step S12

In the powder forming step S12, powder is manufactured from the slurry obtained in the mixing step S11. Specifically, powder is manufactured by spray-drying the slurry. A method of spray-drying is not particularly limited. For example, in the case of a spin disk type, the disk rotates at a high speed (10000 rpm). Therefore, the slurry is ejected while forming into a spherical shape. The slurry having a spherical shape is dried and swirled with high-temperature swirling air (about 200° C.). At this time, the slurry is gradually dried and solidified from the outer side in dry air. The raw material particles in the slurry are coarse, and thus moisture is evaporated from gaps of the raw material particles. As a result, hollow ceramic thermal spray particles can be obtained.

### Solid Solution Step S13

In the solid solution step S13, a solid solution is formed from the powder obtained in the powder forming step S12. Specifically, the obtained powder is heated in a heat-treating furnace at 1450° C. for 10 hours. At this time, the temperature is a set temperature of the heat-treating furnace. Through this heat treatment, ZrO₂ and Yb₂O₃ are diffused and treated to form a solid solution, and a strength suitable for thermal spraying can be obtained.

### Classification Step S14

In the classification step S14, the powder after the formation of the solid solution is classified to obtain ceramic thermal spray particles. In the classification step: S14, it is preferable to classify the powder into particles having a particle size of 150 μm or less. That is, the maximum particle size of the ceramic thermal spray particles is preferably 150 μm or less. When the particle size of the ceramic thermal spray particles is more than 150 μm, the ceramic thermal spray particles may not be melted satisfactorily in the plasma spraying treatment. In addition, in the classification step S14, it preferable to remove ceramic thermal spray particles having a small particle size such that the cumulative particle size d10 is 40 μm or more. A method of classification is not particularly limited, and for example, a gyro sifter can be used.

Hereinafter, the method for manufacturing the ceramic thermal spray particles according to the present disclosure will be. described. In the method for manufacturing the ceramic thermal spray particles according to the present disclosure, ceramic thermal spray particles with which a thermal barrier coating having a low thermal conductivity and excellent thermal cycle durability can be formed can be manufactured.

The technical scope of the present invention is not limited to the above-mentioned embodiment, and various changes can be made within a range not departing from the scope of the present invention. In addition, the components of the above-mentioned embodiment can be appropriately replaced with well-known components within a range not departing from the scope of the present invention.

### EXAMPLES

Next, Examples of the present invention will be described. Conditions in Examples are condition examples adopted to verify the implementability and the effect of the present invention, and the present invention is not limited to these condition examples. The present invention can adopt various condition without departing from the scope of the present invention as long as the object of the present invention is achieved.

### Example 1

A mass ratio between ZrO₂, Yb₂O₃, water, and the surfactant. was set to 84:16:100:1, the mixing was performed using a bead mill to obtain a slurry under conditions of a mixing time of 8 hours and a rotation speed of 18 rpm, and water and the binder were added at a mass ratio 50:2. Powder was prepared from the slurry by spray-drying, and the obtained powder was heated in a heat-treating furnace at 1450° C. for 10 hours. The obtained powder was classified (40 μm to 150 μm) to obtain ceramic thermal spray particles according to Example 1. The ceramic thermal spray particles according to Example 1 were embedded in a resin and cut. When cross-sections of the ceramic thermal spray particles were observed, the ceramic thermal spray particles according to Example 1 were hollow particles. When the measurement was performed using a method described below, a standard deviation of concentration of Yb₂O₃ with respect to the total mass of the ceramic thermal spray particles according to Example 1 was ±2.6 mass %, and the cumulative particle size d10 corresponding to 10% of the ceramic thermal spray particles according to Example 1 was 43 μm.

### Example 2

A mass ratio between ZrO₂, Yb₂O₃, water, and the surfactant was set to 84:16:100:1, the mixing was performed using a bead mill to obtain a slurry under conditions of a mixing time of 8 hours and a rotation speed of 25 rpm, and water and the binder were added at a mass ratio 50:2. Powder was prepared from the slurry by spray-drying, and the obtained powder was heated in a heat-treating furnace at 1450° C. for 10 hours. The obtained powder was classified to obtain ceramic thermal spray particles according to Example 2. The ceramic thermal spray particles according to Example 2 were embedded in a resin and cut. When cross-sections of the ceramic thermal spray particles were observed, the ceramic thermal spray particles according to Example 2 were hollow particles. When the measurement was performed using a method described below, standard deviation of concentration of Yb₂O₃ with respect to the total mass of the ceramic thermal spray particles according to Example 2 was ±2.3 mass %, and the cumulative particle size d10 corresponding to 10% of the ceramic thermal spray particles according to Example 2 was 49 μm.

### Example 3

A mass ratio between ZrO₂, Yb₂O₃, water, and the surfactant was set to 84:16:100:1, the mixing was performed using a bead mill to obtain a slurry under conditions of a mixing time of 8 hours and a rotation speed of 5 rpm, and water and the binder were added at a mass ratio 50:2. Powder was prepared from the slurry by spray-drying, and the obtained powder was. heated in a heat-treating furnace at. 1450° C. for 10 hours. The obtained powder was classified (40 μm to 150 μm) to obtain ceramic thermal spray particles according to Example 3. The ceramic thermal spray particles according to Example 3 were embedded in a resin and cut. When cross-sections of the ceramic thermal spray particles were observed, the ceramic thermal spray particles according to Example 3 were hollow particles. When the measurement was performed using a method described below, a standard deviation of concentration of Yb₂O₃ with respect to the total mass of the ceramic thermal spray particles according to Example 3 was ±5.3 mass %, and the cumulative particle size d10 corresponding to 10% of the ceramic thermal spray particles according to Example 3 was 43 μm.

### Example 4

A mass ratio between ZrO₂, Yb₂O₃, water, and the surfactant was set to 84:16:100:1, the mixing was performed using a bead mill to obtain a slurry under conditions of a mixing time of 10 hours and a rotation speed of 25 rpm, and water and the binder were added at a mass ratio 50:2. Powder was prepared from the slurry by spray-drying, and the obtained powder was heated in a heat-treating furnace at 1450° C. for 10 hours. The obtained powder was classified (40 μm to 150 μm) to obtain ceramic thermal spray particles according to Example 4.

The ceramic thermal spray particles according to Example 4 were embedded in a resin and cut. When cross-sections of the ceramic thermal spray particles were observed, the ceramic thermal spray particles according to Example 4 were hollow particles. When the measurement was performed using a method described below, a standard deviation of concentration of Yb₂O₃ with respect to the total mass of the ceramic thermal spray particles according to Example 4 was ±2.5 mass %, and the cumulative particle size d10 corresponding to 10% of the ceramic thermal spray particles according to Example 4 was 51 μm.

### Comparative Example 1

A mass ratio between ZrO₂/Yb₂O₃, water, and the surfactant was set to 84:16:100:1 the mixing was performed using a bead mill to obtain a slurry under conditions of a mixing time of 15 hours and a rotation speed of 10 rpm, and water and the binder were added at a mass ratio 50:2. Powder was prepared from the slurry by spray-drying, and the obtained powder was heated in a heat-treating furnace at. 1450° C. for 10 hours. The obtained powder was classified (40 μm to 150 μm) to obtain ceramic thermal spray particles according to Comparative Example 1. The ceramic thermal spray particles according to Comparative Example 1 were embedded in a resin and cut. When cross-sections of the ceramic thermal spray particles were observed, the ceramic thermal spray particles according to Comparative Example 1 were hollow particles. When the measurement was performed using method described below, a standard deviation of concentration of Yb₂O₃ with respect to the total mass of the ceramic thermal spray particles according to Comparative Example 1 was ±0.2 mass %, and the cumulative particle size d10 corresponding to 10% of the ceramic thermal spray particles according to Comparative Example 1 was 43 μm.

### Comparative Example 2

A mass ratio between ZrO₂, Yb₂O₃, water, and the surfactant was set to 84:16:100:1, the mixing was performed using a bead mill to obtain a slurry under conditions of a mixing time of 15 hours and a rotation speed of 25 rpm, and water and the binder were added at a mass ratio 50:2. Powder was prepared from the slurry by spray-drying, and the obtained powder was heated in a heat-treating furnace at 1450° C. for 10 hours. The obtained powder was classified (40 μm to 150 μm) to obtain ceramic thermal spray particles according to Comparative Example 2. The ceramic thermal spray particles according to Comparative Example 2 were embedded in a resin and cut. When cross-sections of the ceramic thermal spray particles were observed, the ceramic thermal spray particles according to Comparative Example 2 were hollow particles. When the measurement was performed using method described below, a standard deviation of concentration of Yb₂O₃ with respect to the total mass of the ceramic thermal spray particles according to Comparative Example 2 was ±1.2 mass %, and the cumulative particle size d10 corresponding to 10% of the ceramic thermal spray particles according to Comparative Example 2 was 46 μm.

### Comparative Example 3

A mass ratio between ZrO₂, Yb₂O₃, water, and the surfactant was set to 84:16:100:1, the mixing was performed using a bead mill to obtain a slurry under conditions of a mixing time of 15 hours and a rotation speed of 25 rpm, and water and the binder were added at a mass ratio 50:2. Powder was prepared from the slurry by spray-drying, and the obtained powder was classified (40 μm to 150 μm) to obtain ceramic thermal spray particles according to Comparative Example 3 without performing a heat treatment. The ceramic thermal spray particles according to Comparative Example 3 were embedded in a resin and cut. When cross-sections of the ceramic thermal spray particles were observed, the ceramic thermal spray particles according to Comparative Example 3 were hollow particles. When the measurement was performed using a method described below, standard deviation of concentration of Yb₂O₃ with respect to the total mass of the ceramic thermal spray particles according to Comparative Example 3 was ±7.3 mass %, and the cumulative particle size d10 corresponding to 10% of the ceramic thermal spray particles according to Comparative Example 3 was 50 μm.

### Formation of Thermal Barrier Coating Layer

As a test piece, a sample in which a metal bonding layer (Ni: 32 mass %, Cr: 21 mass %, Al: 8 mass %, Y: 0.5 mass %, and Co: the remainder) having a film thickness of 100 μm was formed on a heat-resistant alloy substrate (trade name: IN-738LC) having a thickness of 5 mm using a low-pressure plasma spraying method was used. A ceramic layer (YbsZ layer) was laminated on the metal bonding layer using the manufactured ceramic thermal spray particles according to each of Examples 1 to 4 and Comparative Examples 1 to 3 with an atmospheric pressure plasma spraying method to form a thermal barrier coating layer. In each of the samples, commonly, the thickness of the metal bonding layer (CoNiCrAlY) was 0.1 mm, and the thickness of the ceramic layer (YbSZ) was 0.5 mm.

Standard Deviation of Content of Yb₂O₃, of Ceramic Thermal Spray Particles

Regarding the ceramic thermal spray particles according to Examples 1 to 4 and Comparative Examples 1 to 3, the standard deviation of content of Yb₂O₃ was measured. Specifically, the measurement was performed using the following method. The obtained ceramic thermal spray particles were embedded in a resin and cut. After cutting, the cross-section was polished, and the polished cross-section was randomly analyzed at 10 points by an electron probe microanalyzer. The contents of Yb₂O₃ and the contents of ZrO₂ were calculated from each of the obtained contents (at %) of Yb and Zr obtained by the point analysis to obtain a standard deviation.

### Cumulative Particle Size d10 of Ceramic Thermal Spray Particles

A particle size distribution of the ceramic thermal spray particles according to each of Examples 1 to 4 and Comparative Examples 1 to 3 was measured using a laser scattering diffraction type particle size distribution measuring device (manufactured by Microtrac Retsch GmbH). The cumulative particle size d10 of the ceramic thermal spray particles according to each of Examples 1 to 4 and Comparative Examples 1 to 3 was obtained from the obtained particle size distribution. The maximum particle size of the ceramic thermal spray particles was measured using a mesh. The maximum particle size of the ceramic thermal spray particles according to each of Examples 1 to 4 and Comparative Examples 1 to 3 was 150 μm.

### Thermal Conductivity

The thermal conductivity of the thermal barrier coating layer according to each of Examples 1 to 4 and Comparative Examples 1 to 3 was measured using a laser flash method specified in JIS R1611:2010.

### Thermal Cycle Durability

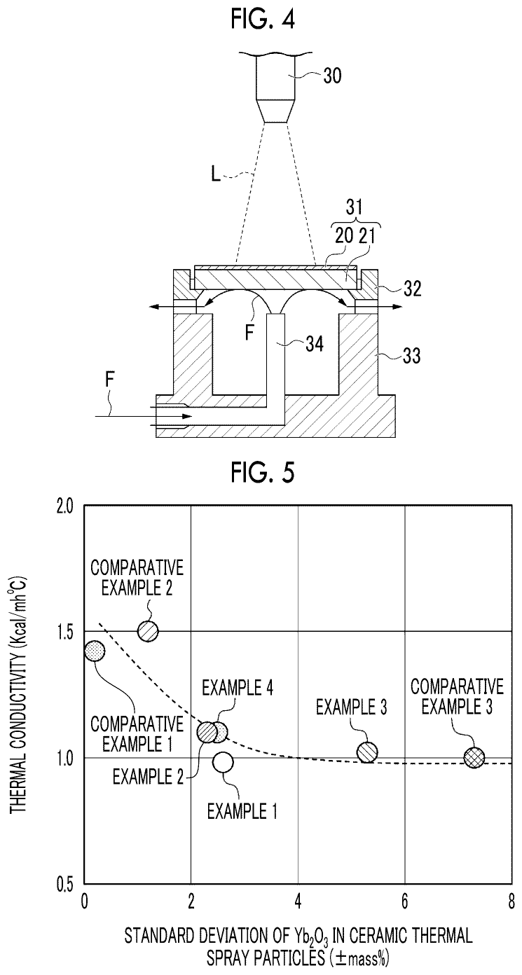

The thermal cycle durability of the thermal barrier coating layer formed of the ceramic thermal spray particles according to each of Examples 1 to 4 and Comparative Examples 1 to 3 was evaluated. FIG. 4 is a schematic cross-sectional view showing laser type thermal cycle tester used for the evaluation of the thermal cycle durability. In the laser type thermal cycle tester shown in the drawing, a sample 31 where the thermal barrier coating layer 20 was formed on the substrate 21 was disposed on a sample holder 32 disposed on a main body portion 33 such that the thermal barrier coating layer 20 faced outward. The sample 31 was irradiated with a laser beam L from a CO₂ laser device 30, and the sample 31 was heated from the thermal barrier coating layer 20 side. In addition, while being heated by the laser device 30, the sample 31 was cooled by a gas flow F from a back surface side thereof, the gas flow F being discharged from a tip of a cold gas nozzle 34 that penetrated the main body portion 33 and that was disposed at a position facing the back surface side of the sample 31 in the main body portion 33.

Assuming that a heating time was 3 minutes, a cooling time was 3 minutes, and maximum surface temperature was 900° C., various maximum surface heating temperatures were set to measure the number of thermal cycles until the ceramic layer was peeled off. Among the obtained surface heating temperatures at which 1000 cycles were exceeded, the maximum temperature was set as a 1000 cycle exceeding temperature. As the 1000 cycle exceeding temperature increases, the thermal cycle durability increases.

FIG. 5 is a diagram showing a relationship between the thermal conductivity of the thermal barrier coating layer and the standard deviation of Yb₂O₃, of the ceramic thermal spray particles. In FIG. 5, a horizontal axis represents the standard deviation (±mass %) of Yb₂O₃ of the ceramic thermal spray particles, and a vertical axis represents the thermal conductivity (kcal/mh° C.). When the standard deviation of Yb₂O₃in the ceramic thermal spray particles was less than 2.0% (Comparative Examples 1 and 2), the thermal conductivity tended to increase. In Comparative Examples 1 and 2, it is presumed that, since a stirring time increased, the materials were uniformly mixed, and the thermal conductivity increased. on the other hand, when the standard deviation of Yb₂O₃was 2.0% or more, the thermal conductivity tended to decrease. The reason for this is presumed to be that, since the standard deviation (variation) of Yb₂O₃ was high, thermal scattering was likely to occur at an interface between different phases such that the thermal conductivity decreased.

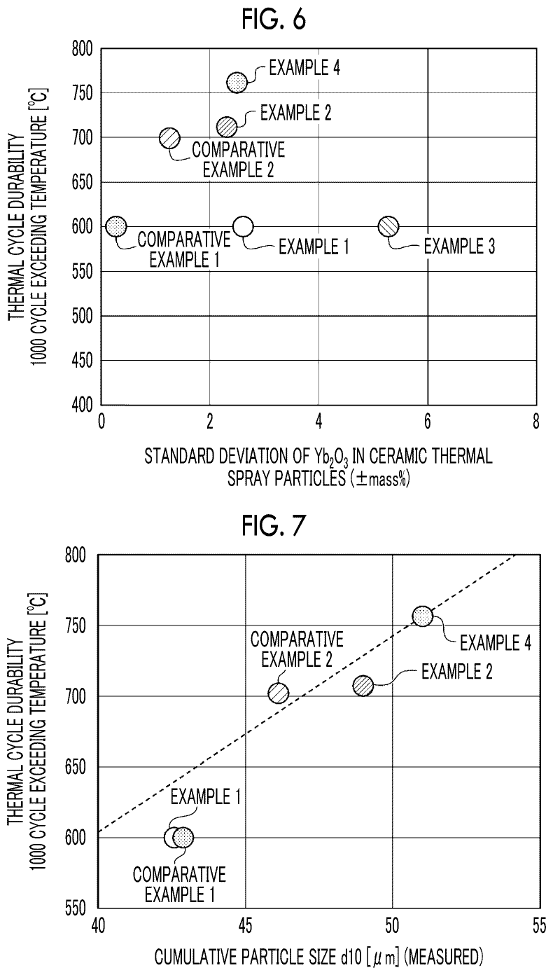

FIG. 6 is a diagram showing a relationship between the thermal cycle durability of the thermal barrier coating layer and the standard deviation of Yb₂O₃ of the ceramic thermal spray particles. In FIG. 6, a horizontal axis represents the standard deviation (±mass %) of Yb₂O₃ of the ceramic thermal spray particles, and a vertical axis represents the 1000 cycle exceeding temperature (° C.). In Examples 1 to 4 and Comparative Examples 1 and 2,sufficient thermal cycle durability was exhibited. However, Comparative Example 3, the 1000 cycle exceeding temperature fell below 600° C. It is presumed that, in Comparative Example 3, a variation in Yb₂O₃ of the ceramic thermal spray particles was large, and thus the thermal cycle durability was low.

FIG. 7 is a diagram showing a relationship between the thermal cycle durability of the thermal barrier coating layer and the cumulative particle size d10 of the ceramic thermal In FIG. 7, a horizontal axis represents the cumulative particle size d10 (μm) of the ceramic thermal spray particles, and a vertical axis represents the 1000 cycle exceeding temperature (° C.). As shown in FIG. 7, as the cumulative particle size d10 of the ceramic thermal spray particles increased, the 1000 cycle exceeding temperature increased. In particular, when the cumulative particle size d10 was 45 μm or more, high thermal cycle durability at 700° C. was exhibited.

It was verified from the above results that, by using the ceramic thermal spray particles and the method for forming the thermal barrier coating layer according to the present disclosure, a thermal barrier coating having a low thermal conductivity and excellent thermal cycle durability can be formed.

### Supplementary Notes

The ceramic thermal spray particles and the method for forming the thermal barrier coating layer according to the above-described embodiment can be understood as follows.

(1) Ceramic thermal spray particles according to a first aspect of the present disclosure contain ZrO₂, and Yb₂O₃, in which a standard deviation of content of Yb₂O₃ is 2 mass % or more and 7.0 mass % or less.

With this configuration, a thermal barrier coating having a low thermal conductivity and excellent thermal cycle durability can be formed.

(2) According to a second aspect of the present disclosure, in the ceramic thermal spray particles according to (1), the content of Yb₂O₃ is 16 mass % or more by mass % with respect to a total mass of the ceramic thermal spray particles.

With this configuration, the thermal cycle durability of the thermal barrier coating layer 20 is improved.

(3) According to a third aspect of the present disclosure, in the ceramic thermal spray particles according to (1) or (2), a cumulative particle size d10 is 40 μm or more.

With this configuration, the thermal cycle durability of the thermal barrier coating layer 20 is further improved.

(4) According to a fourth aspect of the present disclosure, in the ceramic thermal spray particles according to (3), the cumulative particle size d10 is 45 μm or more.

With this configuration, the thermal cycle durability of the thermal barrier coating layer 20 is further improved.

(5) A method for forming a thermal barrier coating layer according to a fifth aspect of the present disclosure includes: a metal bonding layer forming step S1 of forming a metal bonding layer on a substrate; and a ceramic layer forming step S2 of thermally spraying ceramic thermal spray particles onto the metal bonding layer to form a ceramic layer, in which the ceramic thermal spray particles contain ZrO₂ and Yb₂O₃, and a standard deviation of content of Yb₂O₃in the ceramic thermal spray particles is 2 mass % or more and 7.0 mass % or less.

With this configuration, a thermal barrier coating having a low thermal conductivity and excellent thermal cycle durability can be formed.

(6) According to a sixth aspect of the present disclosure, in the method for forming a thermal barrier coating layer according to (5), the content of Yb₂O₃ is 16 mass % or more by mass % with respect to a total mass of the ceramic thermal spray particles.

With this configuration, the thermal cycle durability of the thermal barrier coating layer 20 is further improved.

(7) According to a seventh aspect of the present disclosure, in the method for forming a thermal barrier coating layer according to (5) or (6), a cumulative particle size d10 of the ceramic thermal spray particles is 40 μm or more.

With this configuration, the thermal cycle durability of the thermal barrier coating layer 20 is further improved.

(8) According to an eighth aspect of the present disclosure, in the method for forming a thermal barrier coating layer according to (7), the cumulative particle size d10 is 45 μm or more.

With this configuration, the thermal cycle durability of the thermal barrier coating layer 20 is further improved.

### INDUSTRIAL APPLICABILITY

In the ceramic thermal spray particles and the method for forming the thermal barrier coating layer according to the present disclosure, a thermal barrier coating having a low thermal conductivity and excellent thermal cycle durability can be formed.

### REFERENCE SIGNS LIST

S1: metal bonding layer forming step
S2: ceramic layer forming step
S11: mixing step
S12: powder forming step
S13: solid solution step
S14: classification step

1. Ceramic thermal spray particles comprising ZrO₂ and Yb₂O₃,
wherein a standard deviation of content of Yb₂O₃ is 2 mass % or more and 7.0 mass % or less.

2. The ceramic thermal spray particles according to claim 1,
wherein the content of Yb₂O₃ is 16 mass % or more by mass % with respect to a total mass of the ceramic thermal spray particles.

3. The ceramic thermal spray particles according to claim 1,
wherein a cumulative particle size d10 is 40 μm or more.

4. The ceramic thermal spray particles according to claim 3,
wherein the cumulative particle size d10 is 45 μm or more.

5. A method for forming a thermal barrier coating layer, the method comprising:
a metal bonding layer forming step of forming a metal bonding layer on a substrate; and
a ceramic layer forming step of thermally spraying ceramic thermal spray particles to the metal bonding layer onto form a ceramic layer,
wherein the ceramic thermal spray particles contain ZrO₂ and Yb₂O₃, and
a standard deviation of content of Yb₂O₃ in the ceramic thermal spray particles is 2 mass % or more and 7.0 mass % or less.

6. The method for forming a thermal barrier coating layer according to claim 5,
wherein the content of Yb₂O₃ is 16 mass % or more by mass % with respect to a total mass of the ceramic thermal spray particles.

7. The method for forming a thermal barrier coating layer according to claim 5,
wherein a cumulative particle size d10 of the ceramic thermal spray particles is 40 μm or more.

8. The method for forming a thermal barrier coating layer according to claim 7,
wherein the cumulative particle size d10 is 45 μm or more.
